(19) United States
(12) Patent Application Publication
(10) Pub. No.: US 2011/0236570 A1
(43) Pub. Date: Sep. 29, 2011

(54) EXTRUSION COATING APPARATUS AND COATING FILM FORMING METHOD

(75) Inventor: Ryochi HIGASHI, Minami-Ashigara-shi (JP)

(73) Assignee: FUJIFILM CORPORATION, Tokyo (JP)

(21) Appl. No.: 13/071,106

(22) Filed: Mar. 24, 2011

(30) Foreign Application Priority Data
Mar. 26, 2010 (JP) 2010-072509

(51) Int. Cl. B05D 1/26; B05C 5/00; B05C 11/00

(52) U.S. Cl. 427/162; 118/300

(57) ABSTRACT

An extrusion coating apparatus applying the coating solution to the substrate through a bead in a state in which a continuously running belt-like substrate and a lip surface on an upstream side and a downstream side in the substrate running direction are adjacent to each other, including: a manifold to which a coating solution is supplied, a coating solution discharge opening discharging the coating solution onto the lip surface to the substrate through a slit through which the coating solution is passed from the manifold, and a spacer for regulating a coating width is provided in both end portions in a width direction of the slit; the spacer having a bending portion; further the spacer having a distal end portion formed to cover the lip surface on the upstream side; and the bending portion of the spacer being made of a material with a hardness of HRA 70 or more.

### BACKGROUND OF THE INVENTION

1. Field of the Invention

The present invention relates to an extrusion coating apparatus and a coating film forming method, and more particularly to an extrusion coating apparatus which applies a coating solution to a substrate through a bead in a state in which a continuously running belt-like substrate and a lip surface are adjacent to each other as well as a coating film forming method.

2. Description of the Related Art

The extrusion coating apparatus is configured such that a coating solution supplied to a pocket portion of a slot die is spread in a coating width direction (same as the web width direction) by the pocket portion, and then the coating solution is discharged from a distal end of a slit (also referred to as a slot) having a narrow gap communicatively connected to the pocket portion. Meanwhile, a web to which the coating solution is applied runs by being wound around a backup roller. A bead of coating solution (reservoir of coating fluid) discharged from the distal end of the slit is formed in a lip clearance between the distal end of the slot die and the web. The coating solution is applied to the web through the bead. The coating width of the coating solution to be applied to the web is regulated by the distance between the spacers inserted into both end portions in the slit width direction (same as the web width direction).

What really matters for stable application by the extrusion coating apparatus is whether a stable bead is formed or not. In particular, what has been required in recent years is to increase the application line speed (web running speed) by improving productivity as well as to reduce the film thickness of the applied coating solution. Such an increase in application speed and reduction in film thickness often cause the bead to be cut and broken from both end portions in the bead width direction (same as the web width direction). Thus, it is important to stabilize the bead state in both end portions in the bead width direction. Unstable beads in end portions in the bead width direction cause a film thickness distribution in the width direction of the applied coating film.

As one of the methods of stabilizing beads, for example, Japanese Patent Application Laid-Open No. 2001-300394 discloses a method of depressurizing by pulling the beads on the upstream side in the web running direction.

In addition, there have been invented various methods of improving the uniformity of film thickness in the width direction of a thin film coating by improving the slot gap distribution in the web width direction of a slot die in the coating width direction and the distribution in the web width direction of a lip-to-web gap in the coating width direction with a high degree of accuracy.

However, when a coating solution with a low viscosity (e.g., 10 cP or less) is applied to a slot die, a remarkable capillary phenomenon occurs in a narrow lip clearance portion thereof. As a result, wetting and spreading phenomena occur that the coating solutions in the coating end portions tend to be wet and spread further towards the outer sides (in the web end direction) thereof. In particular, for a thin film coating, the wetting and spreading phenomena have a large effect on the thickness distribution of the coating film in the coating width direction. As a result, the final product has a non-uniform property in the width direction and a reduced effective width thereof.

Japanese Patent Application Laid-Open No. 2001-170542 proposes a method of suppressing the wetting and spreading by changing the shape of a spacer for varying the coating width of the slot die.

However, the bead state of both end portions in the bead width direction cannot sufficiently stabilized simply by depressurizing the beads as disclosed in Japanese Patent Application Laid-Open No. 2001-300394. Moreover, the wetting and spreading of the coating solution in the coating end portion cannot be suppressed and the film thickness distribution in the coating film width direction cannot be sufficiently improved simply by changing the shape of the spacer as disclosed in Japanese Patent Application Laid-Open No. 2001-170542.

More specifically, the wetting and spreading occur under the conditions that the capillary force in the web width direction and in the end direction applied to the beads in a lip-to-web gap formed between the lip tip of the slot die and the web is relatively large and the force of being pulled from the solution on the web during transfer is relatively small. When the coating solution has a high solution viscosity and a wide lip-to-web gap, the capillary force is small, but when a thin film coating requiring a coating solution with a low solution viscosity and a narrow lip-to-web gap is performed, the capillary force increases, thus manifesting the wetting and spreading.

More specifically, the conventional thin film coating needs to further reduce the lip-to-web gap of the slot die and thereby the capillary force increases. Thus, it is difficult to sufficiently prevent the wetting and spreading simply by changing the shape of the spacer a little. Further, a small lip-to-web gap is susceptible to the effect (non-uniform thickness of a ground coating layer, curling due to the ground coating layer, a depression around the edge of the substrate itself, and a depression caused by transfer) of the variation in thickness and shape of the web, and particularly the lip-to-web gap of the end portion in the coating width direction is susceptible to variation. Thus, it is further difficult to stably hold a pin (meniscus position of a bead) formed in both end portions in the bead width direction simply by changing the shape of the spacer.

### SUMMARY OF THE INVENTION

In view of the above considerations, the present invention has been made, and an object of the present invention is to provide an extrusion coating apparatus which can suppress reduction in film thickness due to wetting and spreading in both end portions of a coating film by stabilizing the bead state in the both end portions in the bead width direction.

In order to achieve the above object, the present invention provides an extrusion coating apparatus applying the coating solution to the substrate through a bead in a state in which a continuously running belt-like substrate and a lip surface on an upstream side and a downstream side in the substrate running direction are adjacent to each other, comprising:

a manifold to which a coating solution is supplied,

a coating solution discharge opening which discharges the coating solution onto the lip surface to the substrate through a slit through which the coating solution is passed from the manifold, and

a spacer for regulating a coating width is provided in both end portions in a width direction of the slit; the spacer having a bending portion; further the spacer having a distal end portion formed to cover the lip surface on the upstream side; and the bending portion of the spacer being made of a material with a hardness of HRA 70 or more.

According to the present invention, coating is performed in such a manner that a spacer which is inserted into slit both end portions for regulating the coating width and has a bending portion, and whose distal end portion covers the lip surface on the upstream side in the web running direction of the extrusion coating apparatus is protruded from the slit tip and comes close to a surface of continuously running substrate, namely, web, thereby stabilizing the bead state in both end portions in the bead width direction when the coating starts and while the coating is being performed. More specifically, when a small amount of coating solution with a low viscosity is applied by an extrusion coating apparatus, the meniscus tends to be unstable and is susceptible to wetting and spreading, but the spacer covering up to the lip surface on the upstream side is used to physically block the wetting and spreading, thereby suppressing the wetting and spreading.

Moreover, the present invention is configured such that the spacer has at least a bending portion made of a hard material with an HRA (Rockwell hardness) 70 or more. If the spacer is made of a soft material such as a plastic, the spacer cannot be made with sufficient machining accuracy or may be bent when used, and thus the spacer cannot tightly contact the lip surface. As a result, the distal end of the spacer contacts and cuts the web, thus producing cutting scrap or the coating solution leaks and spreads from a gap between the spacer and the lip. Note that the examples of the material with an HRA of 70 or more include an ultra-hard steel and ceramic (alumina and zirconia).

Here, the shorter the distance between the spacer and the web is, the more effective it is to prevent the wetting and spreading. Further, the longer the length for covering the lip surface on the upstream side is, the more effective the spacer covering the lip surface on the upstream side is. This is because when the length for covering the lip surface on the upstream side is small, the coating solution is wet and spread into a lower portion of the lip surface on the upstream side.

Thus, according to the present invention, preferably a ratio of the length of the lip surface on the upstream side covered by the spacer to the length of the lip surface on the upstream side is 50% or more. Note that the length for covering the lip surface on the upstream side is preferably equal to or less than the length of the lip surface on the upstream side as a maximum. Even if the spacer covers more than the length of the lip surface on the upstream side, no particular problems occur. However, in order to suppress the wetting and spreading, it is sufficient for the spacer to cover up to the length of the lip surface on the upstream side.

Further, according to the present invention, the thickness of the protrusion of the distal end portion from the lip on the upstream side is preferably equal to or greater than 10 μm. The thickness of 10 μm or more allows the wetting and spreading to be effectively suppressed.

Furthermore, the present invention particularly exerts an effect when the coating solution to be applied to the web has a solution viscosity of 10 cP or less.

The above described solution viscosity of 10 cP or less defines the solution viscosity of the coating solution particularly to exert the effect of the present invention. Note that the lower the solution viscosity is, the more the effect of the present invention is exerted. When the solution viscosity is equal to or less than 5 cP, the effect of the present invention is further exerted. When the solution viscosity is equal to or less than 3 cP, the effect of the present invention is still further exerted. When the solution viscosity is equal to or less than 1 cP, the effect of the present invention is yet further exerted.

The coating film formed by using the extrusion coating apparatus of the present invention can stabilize the bead state in both end portions in the bead width direction, and thus allows the wetting and spreading of the coating solution in both end portions to be less than 4.0 mm on one side.

As described above, the extrusion coating apparatus of the present invention can stabilize the bead state in both end portions in the bead width direction and thus can suppress the reduction in film thickness due to wetting and spreading in both end portions of the coating film.

### BRIEF DESCRIPTION OF THE DRAWINGS

FIG. 1 is a plan view of an extrusion coating apparatus of the present invention as seen from above;

FIG. 2 is a sectional side view of the extrusion coating apparatus of the present invention; and

FIG. 3 is a perspective view of the extrusion coating apparatus of the present invention.

### DETAILED DESCRIPTION OF THE PREFERRED EMBODIMENTS

Now, by referring to the accompanying drawings, a preferred embodiment of the extrusion coating apparatus according to the present invention will be described in detail.

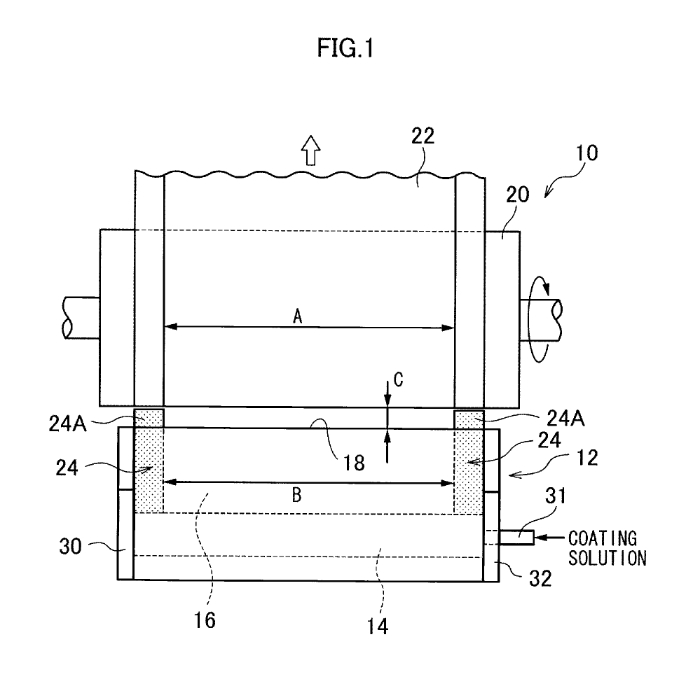

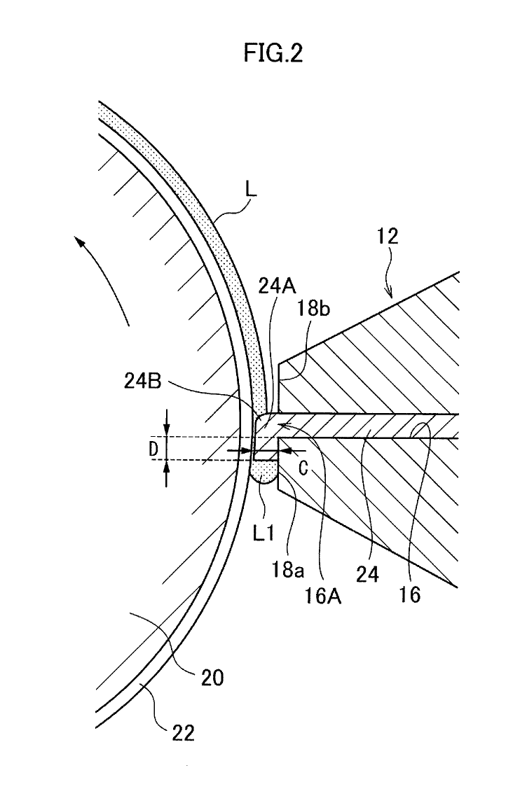

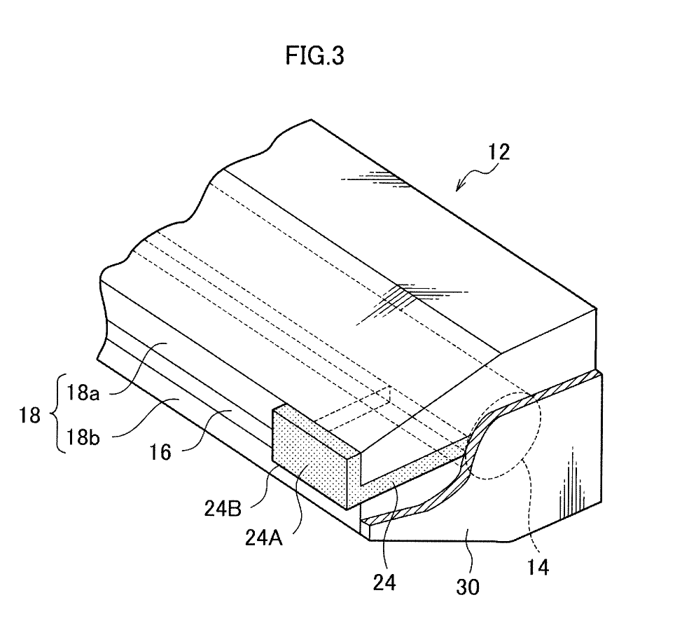

FIG. 1 is a plan view of an extrusion coating apparatus 10 of the present invention as seen from above; FIG. 2 is a sectional side view thereof; and FIG. 3 is a perspective view illustrating the essential parts thereof.

As illustrated in these figures, a slot die 12 includes a pocket portion 14 inside a head thereof and a narrow slit 16 communicatively connected to the pocket portion 14. A coating solution discharge opening at a distal end of the slit 16 opens on a substantially flat lip surface 18 at a distal end of the head. A both end opening portion through which the pocket portion 14 passes is blocked by side plates 30 and 32 provided on both end surfaces of the slot die 12.

The both end opening portion is connected to a solution supply line 31 which supplies a coating solution to the pocket portion 14 through one side plate 32. Note that the method of supplying a coating solution to the pocket portion 14 is not limited to the method of supplying a coating solution from one side by blocking the other end side of the pocket portion 14. For example, a coating solution may be supplied from a central portion of the pocket portion 14 so as to be split to both ends, or a coating solution may be supplied from one side of the pocket portion 14 so as to be pulled out from the other direction.

In FIGS. 1 to 3, a backup roller 20 is arranged close to and opposite to the lip surface 18 of the slot die 12. A web 22 to which a coating solution L is applied is supported by being wound around the backup roller 20 and continuously runs in a direction indicated by the arrow. The gap between the lip surface 18 at the distal end of the die and the surface of the web wound around the backup roller 20 is generally set in a range from 30 μm to 300 μm. The gap is set appropriately according to the coating thickness, the coating speed, the property (viscosity, etc.) of the coating solution L, the reduction in bead pressure, and like. Basically, the lower the viscosity of the solution, the more wetting and spreading occur. In light of this, the gap between the distal end surface of the spacer and the web needs to be narrowed. In addition, the higher the reduction in bead pressure, the more the bead is pulled toward the upstream side in the web transfer direction. In light of this, the length of the spacer for covering the lip tip portion needs to be longer. Thus, the spacer thickness and the length for covering the lip surface may be appropriately adjusted in order to prevent the wetting and spreading of the bead. Note that according to the present invention, the bending portion of the spacer is made of a hard material with an HRA of 70 or more. Thus, the distal end portion of the spacer is conveniently made of the same material. However, when such a hard material contacts the web, the relatively soft web is hurt. Therefore, when the distal end portion of the spacer is made of a material with an HRA of 70 or more, the thickness of the distal end portion of the spacer is preferably set such that the distal end portion of the spacer comes close to but does not contact the web.

Thereby, the coating solution L discharged from the slit 16 is cross-linked between the lip surface 18 and the web 22 to form a bead L1 (reservoir of coating fluid, see FIG. 2). Then, through the bead L1, the coating solution L is applied to the web 22.

Note that as illustrated in FIG. 1, a coating width A of the coating solution L applied to the web 22 is regulated by an interval (distance) B between a pair of spacers 24 inserted into both end portions in the width direction (same as the web width direction) of the slit 16. Each spacer 24 is protruded from the distal end of the slit 16 so as to be close to the surface of the web 22 wound around the backup roller 20.

Then, the coating solution supplied to the pocket portion 14 of the slot die 12 widely flows in the web width direction in the pocket portion 14, rises through the slit 16, and is discharged from the slit discharge opening 16A. The discharged coating solution is applied to the web 22 while forming a bead between the lip surface 18 of the coating head and the web 22 running close to the lip surface 18. More specifically, the coating solution is applied to the web under a balanced condition between a discharging force of the coating solution discharged from the discharge opening 16A at the distal end of the slit and a pressing force of the web 22 pressing the distal end portion of the coating head. Accordingly, an extremely thin coating film is formed on the web surface.

Here, according to the present invention, the spacer 24 has a distal end portion 24A covering a lip surface 18a on the upstream side of the lip surface 18.

The spacer 24 requires at least the bending portion 24B to made of a material with an HRA (Rockwell hardness) of 70 or more, and more specifically, preferably an ultra-hard steel or ceramic (alumina and zirconia). If the distal end portion 24A of the spacer 24 is made of a soft material (metal with an HRA of less than 70) such as a plastic, the spacer 24 cannot be made with sufficient machining accuracy or may be bent when used, and thus the spacer cannot tightly contact the lip surface. As a result, the distal end portion 24A thereof contacts and cuts the web 22, thus producing cutting scrap or the coating solution leaks and spreads from a gap between the spacer and the lip surface 18a.

Thus, the coating solution is applied by the spacer 24 having the distal end portion 24A formed to cover the lip surface 18a on the upstream side, thereby stabilizing the bead state in both end portions in the bead width direction when the coating starts and while the coating is being performed. More specifically, when a small amount of coating solution with a low viscosity is applied by an extrusion coating apparatus, the meniscus tends to be unstable and is susceptible to wetting and spreading, but the spacer covering up to the lip surface on the upstream side is used to physically block the wetting and spreading, thereby suppressing the wetting and spreading.

Here, the “wetting and spreading” refers to that the end portion of the coating solution spreads over the coating width. More specifically, in FIG. 1, the wetting and spreading width refers to a value obtained by dividing the difference between the coating width A of the coating solution L and the interval B between the pair of spacers 24 by 2.

Note that the length D (see FIG. 2) of the spacer 24 for covering the lip surface 18a on the upstream side is preferably equal to or greater than 300 μm. Here, the length for covering the lip surface on the upstream side is preferably equal to or less than the length of the lip surface on the upstream side as a maximum. Even if the spacer 24 covers more than the length of the lip surface 18a on the upstream side, no particular problems occur. However, in order to suppress the wetting and spreading, it is sufficient for the spacer to cover up to the length of the lip surface on the upstream side.

Further, according to the present invention, the thickness C of the protrusion of the distal end portion 24A from the lip surface 18a on the upstream side is preferably equal to or greater than 10 μm. The thickness equal to or greater than 10 μm can effectively suppress the wetting and spreading.

Now, the operation of the extrusion coating apparatus 10 configured as described above will be described.

The coating solution L supplied to the pocket portion 14 in the slot die 12 widely flows in the coating width direction (same as the web width direction) in the pocket portion 14, rises through the slit 16 whose coating width is regulated by the pair of spacers 24, and is discharged from the distal end of the slit. Thereby, the coating solution L is cross-linked in a gap C between the lip surface 18 of the slot die 12 and the web 22 to form a bead L1 (reservoir of coating fluid).

In such coating, the wetting and spreading of a coating film in both end portions in the bead width direction (same as the web width direction) reduces the film thickness thereof.

For example, when a high-speed thin film coating is performed using a coating solution with a low viscosity (10 cP or less), the wetting and spreading of the coating solution increases in the coating end portions and thus it is difficult to stabilize the bead in both end portions in the bead width direction. This causes a film thickness distribution in the width direction of the coating film.

In light of this, according to the present invention, the distal end portion 24A covering the lip surface 18a on the upstream side is arranged close to the spacer 24. Thereby, the both end portions in the bead width direction contact the spacer 24 so as to be stably held and the wetting and spreading of the coating solution in the coating end portion can be suppressed.

It should be noted that the present embodiment has described the preferred shape of the spacer 24, but is not limited to this shape and may include any shape not departing from the spirit and scope of the present invention.

### EXAMPLE 1

Now, an example of the extrusion coating apparatus of the present invention will be described.

The web, the coating head, the coating conditions, and the coating solution used for the test are as follows.

A PET film with a width of 800 mm and a thickness of 15 μm was used as the web.

An extrusion-type coating head with a slit width of 1000 mm, a slit gap of 0.15 mm, and a length of the lip surface on the upstream side in the web running direction of 350 μm was used as the coating head.

A coating solution for an antireflective film was used as the coating solution. The coating solution has a refractive index of 1.42. To 93 g of a methylethylketone solution containing 6% by weight of thermally crosslinked fluorochemical polymer (JN-7228, manufactured by JSR Corporation), 8 g of MEK-ST (having an average particle size 10 nm to 20 nm, a methylethylketone dispersion of SiO₂ sol with a solid concentration of 30% by weight, manufactured by Nissan Chemical Industries, Co., Ltd.), 94 g of methylethylketone, and 6 g of cyclohexanone were added and stirred. Then, the solution was filtered by the polypropylene filter (PPE-01) with a hole size of 1 μm to prepare a coating solution for a low refractive index layer. The coating solution had a viscosity of 0.5 cP.

In test 1, the spacer was made of chrome steel (chrome steel ball with an HRA of 65 and SUJ-2 manufactured by Ito Seisakusho Co., Ltd.) which was used for coating with a lip-to-web gap of 150 μm. The thickness of the protrusion was 0.

In test 2, the spacer made of chrome steel (chrome steel ball with an HRA of 65 manufactured by Ito Seisakusho Co., Ltd.) was used for coating with the spacer having the distal end portion protruded from the distal end of the slot abutting against the web surface. The thickness of the protrusion was 1000 μm.

In test 3, the spacer made of chrome steel (chrome steel ball with an HRA of 65 manufactured by Ito Seisakusho Co., Ltd.) was used for coating with the spacer covering the distal end portion of the lip surface on the upstream side abutting against the web surface. The length for covering the distal end portion was 350 μm and the thickness of the protrusion was 140 μm (the length of the distal end portion covering the lip surface on the upstream side in the web running direction/the length of the lip surface on the upstream side in the web running direction=350/350=100%).

In test 4, the spacer made of ultra-hard steel (with an HRA of 89.5 and V 30 manufactured by Nippon Tungsten Co., Ltd.) was used for coating with the spacer covering the distal end portion of the lip surface on the upstream side abutting against the web surface. The length of the distal end portion of the spacer covering the lip surface on the upstream side in the web running direction was 175 μm and the thickness of the protrusion of the spacer was 70 μm (the length of the distal end portion covering the lip surface on the upstream side in the web running direction/the length of the lip surface on the upstream side in the web running direction=175/350≅50%).

In test 5, the spacer made of ultra-hard steel (with an HRA of 89.5 and V 30 manufactured by Nippon Tungsten Co., Ltd.) was used for coating with the spacer covering the distal end portion of the lip surface on the upstream side abutting against the web surface. The length for covering the distal end portion was 175 μm, and the thickness of the protrusion was 140 μm (the length of the distal end portion covering the lip surface on the upstream side in the web running direction/the length of the lip surface on the upstream side in the web running direction=175/350≅50%).

In test 6, the spacer made of ultra-hard steel (with an HRA of 89.5 and V 30 manufactured by Nippon Tungsten Co., Ltd.) was used for coating with the spacer covering the distal end portion of the lip surface on the upstream side abutting against the web surface. The length for covering the distal end portion was 300 μm and the thickness of the protrusion was 10 μm (the length of the distal end portion covering the lip surface on the upstream side in the web running direction/the length of the lip surface on the upstream side in the web running direction=300/350≅86%).

In test 7, the spacer made of ultra-hard steel (with an HRA of 89.5 and V 30 manufactured by Nippon Tungsten Co., Ltd.) was used for coating with the spacer covering the distal end portion of the lip surface on the upstream side abutting against the web surface. The length for covering the distal end portion was 350 μm, and the thickness of the protrusion was 140 μm (the length of the distal end portion covering the lip surface on the upstream side in the web running direction/the length of the lip surface on the upstream side in the web running direction=350/350=100%).

In test 8, the spacer made of alumina (alumina ball with an HRA of 85 and SSA-999W-5 manufactured by AS ONE Corporation) was used for coating with the spacer covering the distal end portion of the lip surface on the upstream side abutting against the web surface. The length of the distal end portion of the spacer covering the lip surface on the upstream side in the web running direction was 175 μm, and the thickness of the protrusion of the spacer was 70 μm (the length of the distal end portion covering the lip surface on the upstream side in the web running direction/the length of the lip surface on the upstream side in the web running direction=175/350≅50%).

In test 9, the spacer made of alumina (alumina ball with an HRA of 85 and SSA-999W-5 manufactured by AS ONE Corporation) was used for coating with the spacer covering the distal end portion of the lip surface on the upstream side abutting against the web surface. The length for covering the distal end portion was 175 μm, and the thickness of the protrusion was 140 μm (the length of the distal end portion covering the lip surface on the upstream side in the web running direction/the length of the lip surface on the upstream side in the web running direction=175/350≅50%).

In test 10, the spacer made of alumina (alumina ball with an HRA of 85 and SSA-999W-5 manufactured by AS ONE Corporation) was used for coating with the spacer covering the distal end portion of the lip surface on the upstream side abutting against the web surface. The length for covering the distal end portion was 300 μm, and the thickness of the protrusion was 10 μm (the length of the distal end portion covering the lip surface on the upstream side in the web running direction/the length of the lip surface on the upstream side in the web running direction=300/350≅86%).

In test 11, the spacer made of alumina (alumina ball with an HRA of 85 and SSA-999W-5 manufactured by AS ONE Corporation) was used for coating with the spacer covering the distal end portion of the lip surface on the upstream side abutting against the web surface. The length for covering the distal end portion was 350 μm, and the thickness of the protrusion was 140 μm (the length of the distal end portion covering the lip surface on the upstream side in the web running direction/the length of the lip surface on the upstream side in the web running direction=350/350=100%).

In test 12, the spacer made of pure-tungsten sintered body (S-TAN with an HRA of 70 manufactured by Nippon Tungsten Co., Ltd.) was used for coating with the spacer covering the distal end portion of the lip surface on the upstream side abutting against the web surface. The length of the distal end portion of the spacer covering the lip surface on the upstream side in the web running direction was 175 μm, and the thickness of the protrusion of the spacer was 70 μm (the length of the distal end portion covering the lip surface on the upstream side in the web running direction/the length of the lip surface on the upstream side in the web running direction=175/350≅50%).

In test 13, the spacer made of pure-tungsten sintered body (S-TAN with an HRA of 70 manufactured by Nippon Tungsten Co., Ltd.) was used for coating with the spacer covering the distal end portion of the lip surface on the upstream side abutting against the web surface. The length for covering the distal end portion was 175 μm, and the thickness of the protrusion was 140 μm (the length of the distal end portion covering the lip surface on the upstream side in the web running direction/the length of the lip surface on the upstream side in the web running direction=175/350≅50%).

In test 14, the spacer made of pure-tungsten sintered body (S-TAN with an HRA of 70 manufactured by Nippon Tungsten Co., Ltd.) was used for coating with the spacer covering the distal end portion of the lip surface on the upstream side abutting against the web surface. The length for covering the distal end portion was 300 μm, and the thickness of the protrusion was 10 μm (the length of the distal end portion covering the lip surface on the upstream side in the web running direction/the length of the lip surface on the upstream side in the web running direction=300/350≅86%).

In test 15, the spacer made of pure-tungsten sintered body (S-TAN with an HRA of 70 manufactured by Nippon Tungsten Co., Ltd.) was used for coating with the spacer covering the distal end portion of the lip surface on the upstream side abutting against the web surface. The length for covering the distal end portion was 350 μm, and the thickness of the protrusion was 140 μm (the length of the distal end portion covering the lip surface on the upstream side in the web running direction/the length of the lip surface on the upstream side in the web running direction=350/350=100%).

The spacer is inserted into both ends of the slot and the coating width is set to three levels: 1300, 1480, and 1500 mm

As a result, in tests 1 to 3, the wetting and spreading of the coating solution in the coating end portion was large as much as 7 mm to 18 mm As a result, the film thickness distribution in the coating film width direction was large as much as 5.7% to 9.5%, which did not achieve a film thickness distribution of 1% or less as the target value for optical film formation.

In contrast to this, in tests 4 to 13, the wetting and spreading of the coating solution in the coating end portion was very small as much as 1.5 mm to 4.5 mm As a result, the film thickness distribution in the coating film width direction was very small as much as 0.5% to 1.0%, which achieved the target film thickness distribution of 1% or less.

Note that in tests 4, 8, and 12, the wetting and spreading was 4 5 mm; in tests 5, 9, and 13, the wetting and spreading was 4 0 mm; and in tests 6, 7, 10, 11, 14, and 15, the wetting and spreading was 3.5 mm or less.

It is understood from the above test results that the coating film applied by the extrusion coating apparatus of the present invention can suppress the reduction in film thickness due to wetting and spreading in both end portions of the coating film.

Note that an adjustment was made on the coating solution by changing the amount of a solvent thereof to have a viscosity of 10 cP and then the same tests were made using the above spacer. As a result, the same and similar trend was observed.

What is claimed is:

1. An extrusion coating apparatus applying the coating solution to the substrate through a bead in a state in which a continuously running belt-like substrate and a lip surface on an upstream side and a downstream side in the substrate running direction are adjacent to each other, comprising:
a manifold to which a coating solution is supplied,
a coating solution discharge opening which discharges the coating solution onto the lip surface to the substrate through a slit through which the coating solution is passed from the manifold, and
a spacer for regulating a coating width is provided in both end portions in a width direction of the slit; the spacer having a bending portion; further the spacer having a distal end portion formed to cover the lip surface on the upstream side; and the bending portion of the spacer being made of a material with a hardness of HRA 70 or more.

2. The extrusion coating apparatus according to claim 1, wherein a ratio of the length of the lip surface on the upstream side covered by the spacer to the length of the lip surface on the upstream side is 50% or more.

3. The extrusion coating apparatus according to claim 1, wherein the thickness of the protrusion of the distal end portion from the lip on the upstream side is equal to or greater than 10 μm.

4. The extrusion coating apparatus according to claim 1, wherein the coating solution to be applied to the substrate has a solution viscosity of 10 cP or less.

5. A coating film forming method comprising applying a coating solution using the extrusion coating apparatus of claim 1.

6. The coating film forming method according to claim 5, wherein the wetting and spreading in both end portions of the coating solution applied to the continuously running belt-like substrate is less than 4.0 mm
